(19) United States
(12) Patent Application Publication
(10) Pub. No.: US 2019/0027880 A1
(43) Pub. Date: Jan. 24, 2019

(54) POWER ADAPTER FOR CUTTING OFF STANDBY POWER AND CONTROL METHOD THEREFOR

(71) Applicant: Chang-Ho KIM, Anyang-si (KR)

(72) Inventor: Chang-Ho KIM, Anyang-si (KR)

(21) Appl. No.: 16/067,831

(22) PCT Filed: Jan. 4, 2017
(86) PCT No.: PCT/KR2017/000071

§ 371 Date: Jul. 3, 2018

(30) Foreign Application Priority Data
Jan. 4, 2016 (KR) 10-2016-0000241

(51) Int. Cl. H01R 31/06; H02J 9/00; H01R 13/70

(52) U.S. Cl. CPC H01R 31/065; H02J 2009/007; H01R 13/70; H02J 9/005

(57) ABSTRACT

A power adapter (1) for cutting off standby power and a control method therefor are disclosed, the power adapter (1) comprising a power supply unit generating various kinds of power required for an electronic product (400) so as to supply the generated power through an adapter jack. The power adapter (1) comprises: a control unit (80) including at least one microprocessor (U1); a power switching unit (10) configured to cut off the power supplied to the electronic product and cut off a power supply to the power adapter when the power of the electronic product is turned “off” and a battery is fully charged or when the electronic product is disconnected, and to supply power under the control of the control unit (80); a current sensing unit (CT) configured to sense that the power of the electronic product is turned “off” and the battery thereof is fully charged; an electronic product connection sensing unit (50) for checking whether the electronic product is connected in a state in which power is cut off so as to provide the checking result to the control unit (80); a sleep power source unit (30) having a battery to be charged with power from the power supply unit (20) when the power is supplied, and configured to supply power only to the microprocessor (U1) and the product connection sensing unit (50) even when the power switching unit (10) is disconnected; a sensing power switching means (40) configured to supply operating power only during periodic checking of whether the electronic product is connected in a state in which power is cut off; and a sleep power sensing means for monitoring a voltage of the sleep power source unit (30) so as to prevent an operation error due to over-discharge of the sleep power source unit (30) when power is cut off. The power adapter of the present invention adds a circuit for the power adapter without a design change of the electronic product such that a conventional power supply jack of the electronic product can be connected and used as is.

### CROSS-REFERENCE TO RELATED APPLICATIONS

This patent application is a national-stage application of International Patent Application No. PCT/KR2017/000071, filed on Jan. 4, 2017, which claims priority under 35 U.S.C. § 119 to Korean Patent Application No. 10-2016-0000241, filed on Jan. 4, 2016, in the Korean Intellectual Property Office, the disclosures of which are incorporated by reference herein in their entireties.

### TECHNICAL FIELD

The present invention relates to technology for reducing standby power in power adapters used in electronic devices (including laptop computers, net books, PDAs, tablet PCs, or other terminals, which are referred to herein as “electronic devices”), and more specifically, to a power adapter that automatically cuts off standby power to enable efficient use of energy when an electronic device is disconnected from the power adapter, with the power adapter plugged into a power outlet, or when the battery is fully charged with the electronic device powered off. In particular, the present invention relates to technology for allowing existing power adapters to be used as standby power cutoff power adapters without the need for modifying the electronic devices.

### DISCUSSION OF RELATED ART

Ongoing performance enhancements are demanded to raise energy efficiency by cutting off standby power that continues to consume in the power adapter connected with an electronic device even when the electronic device is powered off.

Power adapters currently in use are regulated to limit their consuming standby power to be less than 0.5 W when the electronic devices are powered off or are disconnected therefrom and may thus be said to meet the regulation to some degree.

However, such conventional power adapters are regulated in terms of standby power alone, causing reactive power to rather increase. Thus, despite meeting the standby power regulation, the power factor is lowered to 10% or less. Hence, actual power consumption corresponds to a voltage of 220V and a current ranging from 25 mA to 35 mA, resulting in a power waste ranging from about 5 W to about 8 W.

About two hundred millions of laptop computers are known to be annually produced worldwide. Assuming that each unit consumes 7 W of standby power on average and that the power adapter remains plugged to the outlet for 14 hours a day, one power adapter consumes a power of 35 KW per year, and for the two hundred millions of units, the overall power waste will be about 7 TWh.

As such, the regulation adopted to reduce energy waste due to standby power results in increased reactive power, causing more power waste nationwide. This goes against what the regulation has originally intended.

A relevant document, e.g., Korean Patent No. 10-1512478, discloses a power adapter and method for cutting off standby power. However, according to the technology set forth therein, the electronic device to be connected with the power adapter requires a design change, and this may raise production costs.

### SUMMARY

The present invention has been conceived to address the above-described issues and aims to provide a power adapter and method for cutting standby power, which may eliminate power waste without the need for changing the way the user uses the electronic device, thereby enabling effective and efficient use of energy even without the user's involvement in using the electronic device.

Another object of the present invention is to provide a power adapter that may automatically cut off standby power to enable efficient use of energy when the electronic device is disconnected from the power adapter with the power adapter plugged to the power outlet or when the battery is fully charged with the electronic device powered off.

Yet another object of the present invention is to provide a power adapter that has a means to determine whether an electronic device is connected to the power adapter while the electronic device is powered off, enabling the electronic device to get power back when the electronic device is connected.

Still another object of the present invention is to provide a power adapter and method for controlling the same, in which the power adapter is modified to add functions to fully cutoff standby power while allowing the output lines and power supply lines of the existing power adapter to be used as they are, without modifying the existing circuitry of the electronic device.

To achieve the objectives, according to a first aspect of the present invention, there is provided a power adapter for cutting off standby power, the power adapter including a power supply unit receiving power from an outside through a power plug, producing various types of power necessary for an electronic device, and supplying the power through an adapter jack, the power adapter comprising a controller including at least one microprocessor, the microprocessor configured to control gathering, computing, and analyzing various data necessary to operate the power adapter and the operation of the power adapter, a power switching unit configured to cut off power supplied to the electronic device and power supplied to the power adapter when the electronic device is powered off and a battery of the electronic device is fully charged or the electronic device is disconnected and to supply power under control of the controller, a current sensor configured to detect the power-off of the electronic device and the full charge of the battery of the electronic device, a product connection sensor configured to identify whether the electronic device is connected with the power is cut off and to provide a result of the identification to the controller, a sleep power unit having a battery to save necessary power from the power supply unit when the power is supplied through the power plug and configured to supply the power only to, at least, the microprocessor of the controller and the product connection sensor when the power switching unit is cut off, a sensing power switching means configured to supply operation power only when the product connection sensor periodically identifies whether the electronic device is connected to further minimize power consumption in the sleep power unit while the power is cut off, a sleep power sensing means configured to monitor a voltage of the sleep power unit to prevent an operation error due to an over discharge of the sleep power unit when the power is cut off, and at least one reverse current prevention means configured to prevent a reverse current from the product connection sensor to the power supply unit or from the power supply unit to the product connection sensor.

According to a second aspect of the present invention, there is provided a power adapter for cutting off standby power, the power adapter including a power supply unit receiving power from an outside through a power plug, producing various types of power necessary for an electronic device, and supplying the power through an adapter jack. The power adapter is substantially the same in configuration as the power adapter as per the first aspect except that it lacks the sensing power switching means.

The sensing power switching means is configured to supply operation power only when the product connection sensor periodically identifies whether the electronic device is connected to further minimize power consumption in the sleep power unit while the power is cut off.

According to the present invention, the power adapter for electronic devices may cut off standby power, which might otherwise be wasted if existing power adapters are used, in a complete and efficient way even without the user's involvement and without the need for changing the way of using the electronic device, thereby enabling eco-friendly and energy-saved use of various electronic devices.

### BRIEF DESCRIPTION OF THE DRAWINGS

The foregoing and other features, aspects, and advantages of the present invention will be apparent from the detailed description taken in conjunction with the accompanying drawings. The same reference denotations are intended to refer to the same members or elements throughout the drawings, wherein:

FIG. 1 is a circuit diagram illustrating a configuration of a power adapter according to an embodiment of the present invention;

FIG. 2 is a circuit diagram illustrating a configuration of a power adapter according to another embodiment of the present invention; and

FIG. 3 is a view illustrating a look of a power adapter and an example of connection between the power adapter and an electronic device according to the present invention.

### DESCRIPTION OF EXEMPLARY EMBODIMENTS

The description below is provided for aid in understanding exemplary embodiments of the present invention and equivalents thereof defined by the appended claims. Although the description sets forth various details for a better understanding of the present invention, they should be regarded merely as examples. Therefore, it will readily be appreciated by one of ordinary skill in the art that various changes or modifications may be made to the embodiments set forth herein without departing from the scope and concept of the present invention.

Although any element or objection is expressed in singular form, it should be intended as encompassing plural elements or objects unless explicitly stated otherwise.

The terms “substantially,” “about,” and “essentially” as used herein does not essentially mean that any feature, parameter, or value need to be an exact one, but is intended to mean that a slight tolerance or variation may be made thereto which is known to one of ordinary skill in the art to exhibit the same effects despite the tolerance or variation.

The detailed description of known functions or elements may be omitted from the description of the embodiments of the present invention for clarity and simplicity of the disclosure.

Hereinafter, preferred embodiments of a power adapter with the functionality of cutting off standby power of an electronic device, according to the present invention, are described below in detail with reference to the accompanying drawings.

The term “electronic device” as used herein encompasses, but is not limited to, laptop computers, net books, PDAs, tablet PCs, or other terminals which may be connected to, or charged via, the power adapter. For ease of description, such product is referred to as an electronic device.

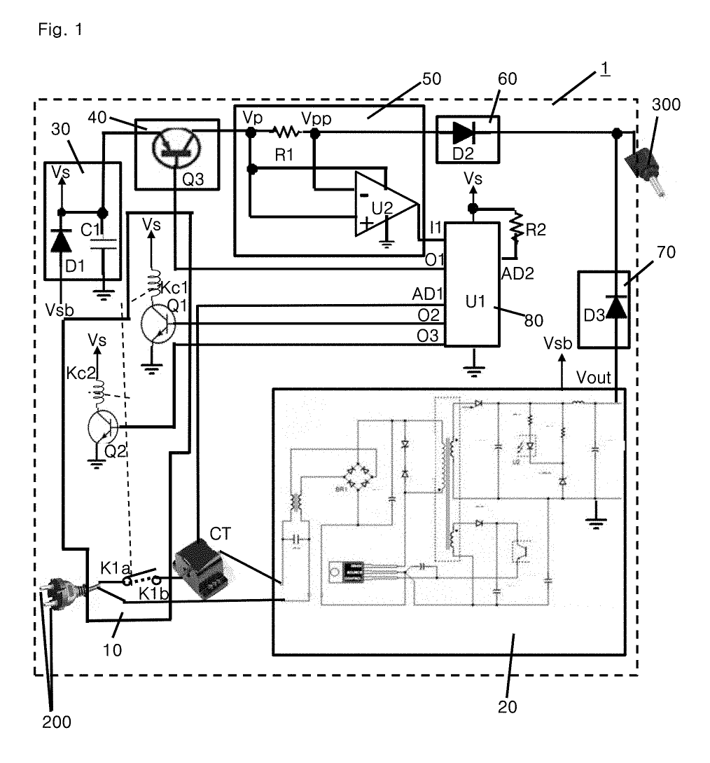

FIG. 1 is a circuit diagram illustrating a power adapter 1 for an electronic device according to an embodiment of the present invention. Referring to FIG. 1, a configuration and operations of the power adapter, according to the present invention, are described in detail.

For ease of description, the electronic device 400 to which the power adapter 1 is applied is a laptop computer, as an example.

The power adapter 1 includes a power switching unit 10. When the electronic device 400 (e.g., a laptop computer) powers off and its battery is fully charged or the electronic device 400 is disconnected, the power switching unit 10 cuts off the power supplied thereto and the power supplied to the electronic device 400, and as necessary, the power switching unit 10 supplies power. The power switching unit 10 includes at least one transistor Q1 and Q2 and at least one latching relays Kc1 and Kc2 that may function as switches under the control of a microprocessor U1 described below. The power switching unit 10 may also be constituted of typical power switching components (not shown), such as Triacs.

The power adapter 1 includes a power supply unit 20 connected to the power switching unit 10. When the electronic device 400 is connected, and the power switching unit 10 is operated so that power is supplied via a power plug 200, the power supply unit 20 produces and supplies power necessary for the power adapter 1 and power necessary for the electronic device 400.

The power adapter 1 includes a current sensor CT constituted of a means to detect the power-off of the electronic device 400 and the full charge of the battery of the electronic device 400.

The power adapter 1 includes a sleep power unit 30. The sleep power unit 30 includes a super capacitor C1 and a diode D1. The sleep power unit 30 is a power supply means to be charged with power when the power is supplied and to only supply the power to a microprocessor U1 of a controller 80 and a product connection sensor 50 even when the power switching unit 10 is cut off, thereby minimizing power consumption.

The sleep power unit 30 may include a typical super capacitor or a rechargeable battery with electrically the same functionality as a charger and a diode, e.g., D1, for reverse current prevention.

The power adapter 1 includes a sensing power switching means 40 connected with the sleep power unit 30 and having at least one transistor Q3. The sensing power switching means 40 may function as a means to supply power only to identify whether an electronic device is connected to the product connection sensor 50, thereby further reducing the power consumption of the sleep power unit 30 upon power-off.

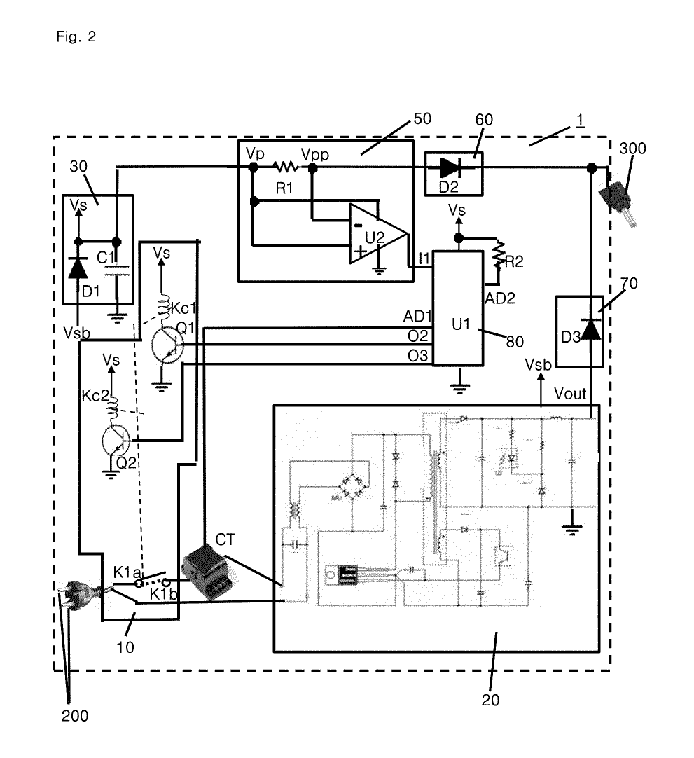

According to an embodiment of the present invention, the sensing power switching means 40 may be omitted from the configuration of the power adapter 1 as described below in connection with FIG. 2. Where the sensing power switching means 40 is omitted, the sleep power unit 30 is configured to continue to supply power to the product connection sensor 50.

The power adapter 1 includes the product connection sensor 50 that may identify whether the electronic device 400 is connected while the power is cut off. The product connection sensor 50 includes a comparator U2 and a resistor R1. The product connection sensor 50 receives power from the sleep power unit 30, senses whether the electronic device 400 is connected, and provides a result of the sensing to the microprocessor U1.

The power adapter 1 includes the controller 80 to overall control collecting various data, computation, analysis, and other various operations of the power adapter 1. The controller 80 may be implemented as at least one microprocessor U1 (which may also be referred to as a microcomputer or micom), and the controller 80 may include at least one memory to store various data necessary for the operations of the power adapter 1.

A sleep power sensor including at least one resistor R2 is connected to the microprocessor U1 of the controller 80. The sleep power sensor may monitor the voltage of the sleep power unit 30 to prevent an operation error due to the over-discharge of the sleep power unit 30 when power is cut off. When, as a result of the monitoring, the voltage of the sleep power unit 30 is a predetermined voltage level or less, the controller 80 may control the power switching unit 10 to supply power regardless of whether the electronic device 400 is connected.

To prevent reverse current from the product connection sensor 50 to the power supply unit 20 while power is cut off, a first reverse current means 70 is connected between the product connection sensor 50 and the power supply unit 20. The first reverse current prevention means 70 includes at least one diode D3.

To prevent reverse current from the power supply unit 20 to the product connection sensor 50 while power is supplied to the electronic device 400, a second reverse current means 60 is connected between the power supply unit 20 and the product connection sensor 50. The second reverse current prevention means 60 includes at least one diode D2.

The power adapter 1 includes the power plug 200 and an adapter jack 300. The power plug 200 has a first end connected to the power switching unit 10 and a second end inserted into a power outlet to receive power from the outside. The adapter jack 300 has a first end connected with the reverse current prevention means 60 and 70 and a second end for supplying power to the electronic device 400.

FIG. 2 is a circuit diagram illustrating a power adapter 1 for an electronic device according to another embodiment of the present invention. The power adapter 1 of FIG. 2 is the same in configuration as the power adapter 1 of FIG. 1 except that the power adapter 1 of FIG. 2 lacks the transistor Q3 between the sleep power unit 30 and the product connection sensor 50.

Since the configuration of FIG. 2 lacks the sensing power switching means 40 between the sleep power unit 30 and the product connection sensor 50, the sleep power unit 30 is configured to continue to supply charged power to the product connection sensor 50. The configuration and operations of the other components than those related to the sensing power switching means 40 are the same as those described above in connection with FIG. 1, and no detailed description thereof is thus given.

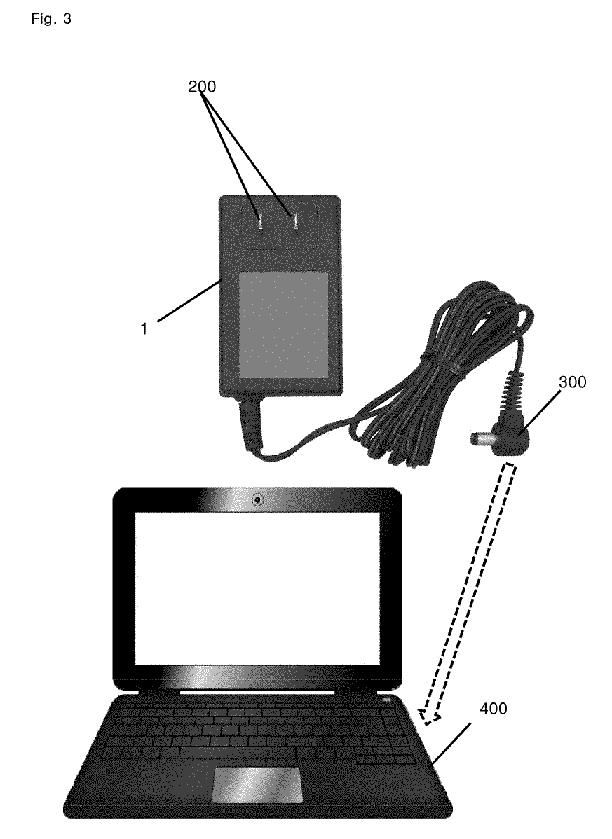

FIG. 3 is a view illustrating an example of a power adapter 1 and an example of connection between the power adapter 1 and an electronic device according to the present invention.

Operations and control methods for the power adapter 1, according to the present invention, are described below with reference to FIGS. 1 to 3.

It is assumed that the power adapter 1 is manufactured and shipped out, with the latching relay contacts K1a and K1b of the power switching unit 10 connected together.

Since the contacts K1a and K1b of the power switching unit 10 are connected together upon inserting the power plug 200 of the power adapter 1 into a power outlet, the power supply unit 20 generates a voltage Vout for supply to the electronic device 400 and a voltage Vsb for supply to the sleep power unit 30 and supply the voltage Vout and the voltage Vsb to each circuit component. The super capacitor C1 of the sleep power unit 30 receives through the diode D1, and is charged with, the voltage Vsb, and a power voltage Vs is supplied to the microprocessor U1 of the controller 80 so that the microprocessor U1 starts to operate. Thus, the microprocessor U1 performs control operations described below.

A. Method for Setting and Controlling Standby Current

Different models of the electronic device 400 have different standby currents. In a method for setting the standby current,

as the electronic device 400 is connected to the power adapter 1 and is supplied power, the microprocessor U1 reads the value of current flowing through the current sensing unit CT as an analog-digital converter input AD1. The input current value is recorded in a buffer, and variations in the current are checked. When a smaller current value than the value previously recorded in the buffer is input, the buffer is updated with the input current value.

Where the electronic device 300 is connected and is used, the current value continues to vary. When the electronic device 400 is powered off and the battery is charged, the current value continues to reduce. When the current value does not change but remains during a predetermined time period T1 (e.g., 20 minutes) or longer, the microprocessor U1 of the controller 80 determines that the battery is fully charged, and since the minimum current value recorded in the buffer is the standby current value, the microprocessor U1 stores and sets, in the memory, the minimum value as the standby current value.

B. Method for Controlling Power Cutoff

(1) Cut Off Power when the Electronic Device is Powered Off but is not Disconnected

Where the electronic device 400 being used is powered off and the battery is fully charged, if the current value reaches the standby current value, the microprocessor U1 of the controller 80 compares the current value read through the AD1 input with the standby current value stored in the memory. Upon determining that the current value read is the standby current value as a result of the comparison, the microprocessor U1 outputs a pulse to the output O2 to turn on, and then, turn off the transistor Q1. At this time, the relay contacts K1a and K1b of the power switching unit 10 are opened, cutting off the power supplied to the power adapter 1, and hence, allowing the standby power of the power adapter 1 to become substantially 0 watt. To minimize power consumption while the power is cut off, the microprocessor U1 of the controller 80 enters a sleep mode and then performs sleep mode control.

As the microprocessor U1, a low-power microprocessor may be adopted which is configured to consume about 1 μA of power or less in the sleep mode, enabling long-term control only with the power charged to the sleep power unit 30.

(2) Cut Off Power when the Electronic Device is Disconnected

When the electronic device 400 is disconnected from the power adapter 1, no current flows through the resistor R1 of the product connection sensor 50, so that no electric potential difference occurs between the voltages Vp and Vpp at both ends of the resistor R1, and thus, the output from the comparator U2 becomes ‘low.’

When the ‘low’ signal is entered to the input I1 f the microprocessor U1 of the controller 80, the microprocessor U determines, based on the ‘low’ signal, that the electronic device 400 is disconnected, and the microprocessor U1 outputs a pulse to the output O2 to turn on and then turn off the transistor Q1. At this time, the relay contacts K1a and K1b of the power switching unit 10 are opened, cutting off the power supplied to the power adapter 1, and hence, allowing the standby power of the power adapter 1 to become 0 watt.

To minimize power consumption while the power is cut off, the microprocessor U of the controller 80 enters the sleep mode and then performs sleep mode control.

C. Sleep Mode Control Method

(1) When the Electronic Device is Disconnected so that Power Supply to the Electronic Device is Cut Off

To further reduce the discharge of power in the sleep power unit 30 in the sleep mode, the output O1 of the microprocessor U1 is rendered to be ‘high’ to turn off the transistor Q3 of the sensing power switching means 40, and the power supply to the product connection sensor 50 is cut off, thereby further curtailing power consumption. To reduce power consumption in the microprocessor U1, the microprocessor U1 is operated in the sleep mode.

The microprocessor U1 of the controller wakes up every time period TP1 (e.g., 10 seconds) to determine whether the electronic device 400 is connected and outputs its output O1 as ‘low’ to turn on the transistor Q3 of the sensing power switching means 40 so that the product connection sensor 50 is supplied power. As such, the microprocessor U1 periodically checks whether the electronic device is connected.

If the electronic device 400 is connected, the output of the product connection sensor 50 becomes ‘high’ and is input to the input I1 of the microprocessor U1 of the controller 80. Then, the microprocessor U1 performs an embedded interrupt routine for determining that the electronic device 400 is being used upon applying the signal to the input I1, outputting a pulse to the output O3 to turn on the transistor Q2 of the power switching unit 10 and performing power supply mode control. The interrupt routine is a control algorithm that is stored in the microprocessor U1 and that is operated whenever necessary.

Unless the electronic device 400 is connected, the output of the product connection sensor 50 is in the ‘low’ state, and thus, after charge mode control is performed, sleep mode 1 below is performed.

Sleep Mode 1

In the sleep mode, the output O1 of the microprocessor U1 is output as ‘high’ to further reduce the discharge of power of the sleep power unit 30. The power consumption is reduced by turning off the transistor Q3 of the sensing power switching means 40 and cutting off power supplied to the product connection sensor 50. To reduce power consumption in the microprocessor U1, the sleep mode control is carried out.

In another embodiment, where the sensing power switching means 40 is not disposed but the sleep power unit 30 is directly connected to the product connection sensor 50 as shown in FIG. 2, the sleep mode control is performed without the need for controlling the sensing power switching means 40.

(3) Where the Electronic Device is Powered Off without Disconnection, and Charging is Done so that the Power Supply is Cut Off

In this case, since the power is cut off with the battery of the electronic device 400 fully charged, the microprocessor U1 of the controller 80 wakes up every relatively long period TP2 (e.g., 30 minutes) in the sleep mode, outputting a pulse to its output O3.

At this time, the transistor Q2 of the power switching unit 10 is turned on and is then turned off so that the relay contacts K1a and K1b are connected together. Thus, power is supplied to the power adapter 1, and the power supply unit 20 supplies power through the diode D3 to the electronic device 400.

Once power is supplied, the current sensing unit CT senses the current and inputs the sensed signal to the input AD1 of the microprocessor U1 of the controller 80. The microprocessor U1 compares the input current value with the pre-stored standby current value. When the input current value is larger than the standby current value, the electronic device is determined to be in use, allowing the power supply to continue.

If the input current value is the standby current value, then the microprocessor U1 outputs a pulse to its output O2 to turn on and then turn off the transistor Q1, so as to cut off the standby power after performing the charge mode control. As the relay contacts K1a and K1b of the power switching unit 10 are opened, the power supplied to the power adapter 1 is cut off.

To minimize power consumption while the power is cut off, the microprocessor U1 of the controller 80 enters the sleep mode and then performs sleep mode control.

D. Power Supply Mode Control

Where the electronic device 400 is connected, current flows through the resistor R1 in the product connection sensor 50 and the second reverse current prevention means 60. Accordingly, an electric potential difference occurs between the voltages Vp and Vpp at both ends of the resistor R1 and the voltage Vpp becomes lower than the voltage Vp. Thus, the input difference is input to the inverter end of the comarator U2, allowing the output of the comparator U2 to become ‘high.’

When the ‘high’ signal is input to the input I1 of the microprocessor U1, the microprocessor U1 executes the interrupt routine stored therein to output a predetermined pulse through the output terminal O3.

In this case, the transistor Q2 of the power switching unit 10 is turned on and then turned off, so that the relay contacts K1a and K1b are connected together, allowing the power adapter 1 to be supplied power and hence supplying power to the electronic device 400.

E. Charge Mode Control

To prevent malfunctions due to over discharge of the sleep power unit 30 as power supply is cut off and the electronic device 400 is not used for a long time or power outage lasts for a long time, the microprocessor U1, whenever waking up, checks the sleep voltage Vs of the sleep power unit 30 through the resistor R2 at the analog-digital converter terminal AD2. When, as a result, Vs is a predetermined voltage Ccd (e.g., 3V) or higher, the microprocessor U1 performs sleep mode 1, and when Vs is less than the voltage Ccd, the microprocessor U outputs a pulse to the output O3.

In this case, the transistor Q2 of the power switching unit 10 is turned on and then turned off, and the relay contacts K1a and K1b are connected together, allowing the power adapter 1 to be supplied power and thereby charging the super capacitor C1 of the sleep power unit 30.

When the super capacitor C1 is fully charged, the microprocessor U identifies the value through the terminal AD2 and outputs a pulse to the output O2 to allow the transistor Q1 to be turned on and then turned off. At this time, the relay contacts K1a and K1b of the power switching unit 10 are opened, so that the power supplied to the power adapter 1 is cut off, and the microprocessor U1 performs the sleep mode control.

Meanwhile, although charging is properly done so that the battery is discharged due to power outage, if the power is restored, power supply is resumed so that the charge mode control is repeated to charge the battery without an error since the relay contacts K1a and K1b remain connected.

The terms and words used herein are provided simply for a better understanding of the present invention and are not limited thereto. Thus, it will readily be appreciated by one of ordinary skill in the art that the embodiments set forth herein are provided as examples and should not be intended as limiting the scope of the present invention and that the scope of the present invention is defined solely by the appended claims and equivalents thereof.

Although some of various embodiments are described herein, it is apparent to one of ordinary skill in the art that numerous modifications or variations may be made thereto. Therefore, it will be appreciated by one of ordinary skill in the art that the appended claims encompass all such modifications or variations without departing from the spirit of the present invention.

1. A power adapter 1 for cutting off standby power, the power adapter 1 including a power supply unit 20 receiving power from an outside through a power plug 200, producing various types of power necessary for an electronic device 400, and supplying the power through an adapter jack 300, the power adapter 1 comprising:
a controller 80 including at least one microprocessor U1, the microprocessor U1 configured to control gathering, computing, and analyzing various data necessary to operate the power adapter 1 and the operation of the power adapter 1;
a power switching unit 10 configured to cut off power supplied to the electronic device 400 and power supplied to the power adapter 1 when the electronic device 400 is powered off and a battery of the electronic device 400 is fully charged or the electronic device 400 is disconnected and to supply power under control of the controller 80;
a current sensor CT configured to detect the power-off of the electronic device 400 and the full charge of the battery of the electronic device 400;
a product connection sensor 50 configured to identify whether the electronic device 400 is connected with the power is cut off and to provide a result of the identification to the controller 80;
a sleep power unit 30 having a battery to save necessary power from the power supply unit 20 when the power is supplied through the power plug 200 and configured to supply the power only to, at least, the microprocessor U1 of the controller 80 and the product connection sensor 50 when the power switching unit 10 is cut off;
a sensing power switching means 40 configured to supply operation power only when the product connection sensor 50 periodically identifies whether the electronic device 400 is connected to further minimize power consumption in the sleep power unit 30 while the power is cut off;
a sleep power sensing means configured to monitor a voltage of the sleep power unit 30 to prevent an operation error due to an over discharge of the sleep power unit 30 when the power is cut off; and
at least one reverse current prevention means 60 or 70 configured to prevent a reverse current from the product connection sensor 50 to the power supply unit 20 or from the power supply unit 20 to the product connection sensor 50.

2. The power adapter 1 of claim 1, wherein the power switching unit 10 includes at least one or more transistors Q1 and Q2 gates of which are connected to outputs O2 and O3, respectively, of the microprocessor U1 and at least one or more latching relays Kc1 and Kc2 respectively connected to collectors of the transistors Q1 and Q2 to perform a switching function under the control of the microprocessor U1 of the controller 80.

3. The power adapter 1 of claim 2, wherein the sleep power unit 30 includes at least one capacitor C1 functioning as a battery to receive a voltage Vsb from the power supply unit 20 and to be charged with a necessary voltage Vs and a diode D1 connected with the capacitor C1.

4. The power adapter 1 of claim 2, wherein the sleep power unit 30 includes a super capacitor or a rechargeable battery having electrically the same function as a charger and a diode for reverse current prevention.

5. The power adapter 1 of claim 3, wherein the sensing power switching means 40 includes at least one transistor Q3 connected between the sleep power unit 30 and the product connection sensor 50.

6. The power adapter 1 of claim 3, wherein the product connection sensor 50 includes at least one comparator U2 having an output terminal connected with the microprocessor U1 of the controller 80 and at least one resistor R1 connected with an input terminal of the comparator U2.

7. The power adapter 1 of claim 1, wherein the microprocessor U1 includes at least one memory for storing various data necessary to operate the power adapter 1.

8. The power adapter 1 of claim 1, wherein the sleep power sensing means includes at least one resistor R2 connected with the microprocessor U1 of the controller 80.

9. The power adapter 1 of claim 1, wherein the at least one reverse current prevention means 70 includes at least one diode D3 connected between the product connection sensor 50 and the power supply unit 20 to prevent a reverse current from the product connection sensor 50 to the power supply unit 20 while the power is cut off.

10. The power adapter 1 of claim 9, wherein the at least one reverse current prevention means 60 includes at least one diode D2 connected between the power supply unit 20 and the product connection sensor 50 to prevent a reverse current from the power supply unit 20 to the product connection sensor 50 while the power is supplied.

11. A power adapter 1 for cutting off standby power, the power adapter 1 including a power supply unit 20 receiving power from an outside through a power plug 200, producing various types of power necessary for an electronic device 400, and supplying the power through an adapter jack 300, the power adapter 1 comprising:
a controller 80 including at least one microprocessor U1, the microprocessor U1 configured to control gathering, computing, and analyzing various data necessary to operate the power adapter 1 and the operation of the power adapter 1;
a power switching unit 10 configured to cut off power supplied to the electronic device 400 and power supplied to the power adapter 1 when the electronic device 400 is powered off and a battery of the electronic device 400 is fully charged or the electronic device 400 is disconnected and to supply power under control of the controller 80;
a current sensor CT configured to detect the power-off of the electronic device 400 and the full charge of the battery of the electronic device 400;
a product connection sensor 50 configured to identify whether the electronic device 400 is connected with the power is cut off and to provide a result of the identification to the controller 80;
a sleep power unit 30 having a battery to save necessary power from the power supply unit 20 when the power is supplied through the power plug 200 and configured to supply the power only to, at least, the microprocessor U1 of the controller 80 and the product connection sensor 50 when the power switching unit 10 is cut off;
a sleep power sensing means configured to monitor a voltage of the sleep power unit 30 to prevent an operation error due to an over discharge of the sleep power unit 30 when the power is cut off; and
at least one reverse current prevention means 60 or 70 configured to prevent a reverse current from the product connection sensor 50 to the power supply unit 20 or from the power supply unit 20 to the product connection sensor 50.

12. The power adapter 1 of claim 11, wherein the power switching unit 10 includes at least one or more transistors Q1 and Q2 gates of which are connected to outputs O2 and O3, respectively, of the microprocessor U1 and at least one or more latching relays Kc1 and Kc2 respectively connected to collectors of the transistors Q1 and Q2 to perform a switching function under the control of the microprocessor U1 of the controller 80.

13. The power adapter 1 of claim 12, wherein the sleep power unit 30 includes at least one capacitor C1 functioning as a battery to receive a voltage Vsb from the power supply unit 20 and to be charged with a necessary voltage Vs and a diode D1 connected with the capacitor C1.

14. The power adapter 1 of claim 12, wherein the sleep power unit 30 includes a super capacitor or a rechargeable battery having electrically the same function as a charger and a diode for reverse current prevention.

15. The power adapter 1 of claim 13, wherein the product connection sensor 50 includes at least one comparator U2 having an output terminal connected with the microprocessor U1 of the controller 80 and at least one resistor R1 connected with an input terminal of the comparator U2.

16. The power adapter 1 of claim 11, wherein the microprocessor U1 includes at least one memory for storing various data necessary to operate the power adapter 1.

17. The power adapter 1 of claim 11, wherein the sleep power sensing means includes at least one resistor R2 connected with the microprocessor U1 of the controller 80.

18. The power adapter 1 of claim 11, wherein the at least one reverse current prevention means 70 includes at least one diode D3 connected between the product connection sensor 50 and the power supply unit 20 to prevent a reverse current from the product connection sensor 50 to the power supply unit 20 while the power is cut off.

19. The server of claim 18, wherein the at least one reverse current prevention means 60 includes at least one diode D2 connected between the power supply unit 20 and the product connection sensor 50 to prevent a reverse current from the power supply unit 20 to the product connection sensor 50 while the power is supplied.

20. A power control method by a power adapter for cutting off standby power, the power control method comprising:
when an electronic device 400 is connected to the power adapter and is supplied power, reading, by a microprocessor U1, a value of a current flowing through a current sensor CT through an analog-digital converter input AD1, recording the input current value in a buffer of the microprocessor U1, identifying a variation in the current, and when a current value smaller than a value previously recorded in the buffer is input, updating the buffer with the input current value; and
if the current value is not reduced but maintained for a predetermined time period T1 or longer when the electronic device 400 is powered off and a battery is charged, determining, by the microprocessor U1, that the battery is fully charged, and storing, in a memory of the microprocessor U1, a minimum value recorded in the buffer as a standby current value, thereby setting the standby current value of the power adapter 1.
